(19) United States
(12) Patent Application Publication
(10) Pub. No.: US 2025/0226512 A1
(43) Pub. Date: Jul. 10, 2025

(54) UNLOCKING DEVICE, BATTERY SWAPPING APPARATUS, AND BATTERY PACK

(71) Applicants: AULTON NEW ENERGY AUTOMOBILE TECHNOLOGY CO., LTD., Guangzhou, Guangdong (CN); SHANGHAI DIANBA NEW ENERGY TECHNOLOGY CO., LTD., Pudong New Area, Shanghai (CN)

(72) Inventors: Jianping Zhang, Pudong New Area, Shanghai (CN); Li Wang, Pudong New Area, Shanghai (CN); Danliang Qiu, Pudong New Area, Shanghai (CN)

(21) Appl. No.: 18/853,417

(22) PCT Filed: Dec. 23, 2022
(86) PCT No.: PCT/CN2022/141479

§ 371 Date: Dec. 23, 2024

(30) Foreign Application Priority Data
Apr. 2, 2022 (CN) CN202210351325.9
Apr. 2, 2022 (CN) CN202220794042.7

(51) Int. Cl. H01M 50/249; B60L 53/80

(52) U.S. Cl. CPC H01M 50/249; B60L 53/80; H01M 2220/20

(57) ABSTRACT

An unlocking device, a battery swapping apparatus, and a battery pack. The unlocking device is used for locking and unlocking a battery pack in an electric vehicle. The unlocking device comprises: an unlocking rod, an unlocking guide block and a driving mechanism. The actuating mechanism is connected to the unlocking guide block and drives the unlocking guide block to move horizontally. An unlocking guide slot is provided on the unlocking guide block, and the unlocking guide slot drives the unlocking rod to move up and down, so that the unlocking rod pushes a locking and unlocking structure for the electric vehicle and the battery pack to implement locking and unlocking.

### CROSS REFERENCE TO THE RELATED APPLICATIONS

The present disclosure is a national phase application of International Application No. PCT/CN2022/141479, field on Dec. 23, 2022, which claims priority to Chinese Patent Application No. CN 2022207940427 filed on Apr. 2, 2022 and Chinese Patent Application No. CN 2022103513259 filed on Apr. 2, 2022, the entire contents of which are incorporated herein by reference.

### TECHNICAL FIELD

The present disclosure relates to the technical field of battery swapping, and particularly relates to an unlocking device, a battery swapping apparatus, and a battery pack.

### BACKGROUND

An existing battery pack of an electric vehicle generally includes a fixed battery pack and a replaceable battery pack, depending on its mounting way. The fixed battery pack is generally fixed to the vehicle, directly with the vehicle as a charged object during charging. The replaceable battery pack is generally mounted in a movable manner, and can be removed at any time and replaced with a new battery pack.

With a tremendously large size and cargo dead weight, an oversized vehicle such as a heavy truck or a light truck puts forward a high demand for a capacity of the battery pack. Only a sufficiently large power capacity can support the oversized vehicle in a distance of hundreds of kilometers. During replacement with a new battery pack, a battery swapping apparatus is required to lock and unlock the battery pack for replacement. Compared with the oversized vehicle having a larger-volume battery pack, the electric vehicle has a lower chassis, such that a space below a vehicle bottom, especially an upper-lower space, is insufficient. Thus, it is difficult for a general battery swapping apparatus to enter the space below the vehicle bottom to lock and unlock the battery pack with an unlocking rod. Further, a liftable unlocking rod is required, otherwise it is difficult to ensure the unlocking rod moves in place and performs unlocking.

### SUMMARY

The technical problem to be solved by the present disclosure is to provide an unlocking device, a battery swapping apparatus, and a battery pack, so as to overcome the defect that in the prior art, it is difficult for an unlocking device to lock and unlock a battery pack in a narrow space below a chassis of an electric vehicle.

The present disclosure solves the above technical problem through the following embodiments.

An unlocking device is configured to lock and unlock a battery pack in an electric vehicle and includes: an unlocking rod, an unlocking guide block and a driving mechanism. The driving mechanism is connected to the unlocking guide block and drives the unlocking guide block to horizontally move. An unlocking guide slot is provided on the unlocking guide block, and the unlocking rod is driven to move up and down by the unlocking guide slot, such that a locking and unlocking structure for the electric vehicle and the battery pack is pushed by the unlocking rod to carry out locking and unlocking.

In the above embodiment, by using the above structural form, a horizontal movement of the driving mechanism is converted into an up-down movement of the unlocking rod by the unlocking device by means of the unlocking guide block, such that a height of the unlocking device is reduced, and unlocking can be completed in a narrow space below a vehicle bottom. Moreover, the unlocking device is compact in a structural layout and beneficial to unlocking of various vehicle types.

In one embodiment, a protruding column portion extending to a side is arranged on the unlocking rod, and the protruding column portion of the unlocking rod is driven to move up and down by the unlocking guide slot, such that the battery pack in the electric vehicle is unlocked by the unlocking rod.

In the above embodiment, by using the above structural form, a split design is used for the driving mechanism. An unlocking member is driven to move by the driving mechanism by means of the unlocking guide block. Through the split design, precision requirements of mounting positions of the driving mechanism and the unlocking member can be reduced, and production cost can be reduced.

In one embodiment, the unlocking device further includes a horizontal guide mechanism. The driving mechanism is arranged at one end of the unlocking guide block, and the unlocking guide block is driven by the driving mechanism to horizontally move in the horizontal guide mechanism, such that the unlocking rod moves up and down along the unlocking guide slot.

In the above embodiment, by using the above structural form, a horizontal movement of the unlocking guide block is guided and restrained by means of the horizontal guide mechanism such that the unlocking rod can be ensured to stably move up and down along the unlocking guide slot to implement unlocking, and a space can be saved in a vertical direction.

In one embodiment, the unlocking rod is mounted in a left-right limiting manner relative to a horizontal moving direction. The unlocking guide slot is an inclined guide slot for guiding the unlocking rod to extend from a lowest position to a highest position. The inclined guide slot is provided on a side wall, in a direction parallel to a moving direction of the unlocking guide block, of the unlocking guide block.

In one embodiment, the unlocking guide slot includes: a first guide portion, where an extending direction of the first guide portion is the same as the moving direction of the unlocking guide block; a second guide portion, where the second guide portion is parallel to the first guide portion and located at a lower end of the first guide portion; and a third guide portion, where one end of the third guide portion is inclined downwards for communication from one end of the first guide slot close to the third guide portion, and the other end of the third guide portion is in communication with one end of the second guide portion close to the third guide portion.

In the above embodiment, by using the above structural form, the unlocking guide slot includes the first guide portion having the same moving direction as the unlocking guide block and a second guide portion parallel to the first guide portion and located at the lower end of the first guide portion. By the first guide portion and the second guide portion, a horizontal movement of the unlocking guide block can be ensured, and horizontal support for stay of a protruding portion of the unlocking rod can be provided. The unlocking guide slot further includes a third guide portion inclined downwards from the first guide portion to be in communication with the second guide portion. Therefore, the protruding portion of the locking rod can be ensured to move up and down.

In one embodiment, the unlocking device further includes a vertical guide slot. A highest point of the vertical guide slot is higher than or as high as a top end of the first guide portion. A lowest point of the vertical guide slot is lower than or as low as a bottom end of the second guide portion. When the unlocking rod is located at the highest position, one end of the first guide portion away from the third guide portion corresponds to a left-side position of the vertical guide slot, or one end of the first guide portion away from the third guide portion is located on a left side of the vertical guide slot. When the unlocking rod is located at the lowest position, one end of the second guide portion away from the third guide portion corresponds to a right-side position of the vertical guide slot, or one end of the second guide portion away from the third guide portion is located on a right side of the vertical guide slot.

In the above embodiment, by using the above structural form, the vertical guide mechanism for guiding the unlocking rod is arranged such that the unlocking rod can be ensured to move up and down in a predetermined direction and prevented from tilting left and right. Further, the unlocking rod can be aligned with an unlocking position and implements unlocking rapidly.

In one embodiment, the unlocking guide slot further includes: a first chamfer arranged at a joint between the first guide portion and the third guide portion; and a second chamfer arranged at a joint between the second guide portion and the third guide portion.

In the above embodiment, by using the above structural form, a chamfer is arranged at a corner of a Z-shaped unlocking guide slot such that a friction force can be reduced when the protruding column portion of the unlocking rod moves in the horizontal guide slot. Further, a jam can be prevented and a smooth movement can be ensured.

In one embodiment, the unlocking rod includes the protruding column portion and a rod body portion. The protruding column portion extends from an outer peripheral surface of the rod body portion into the unlocking guide slot in a radial direction of the rod body portion. The rod body portion is driven, by the unlocking guide slot by means of the protruding column portion, to move up and down in the unlocking guide block.

In the above embodiment, by using the above structural form, the protruding column portion is arranged on the outer peripheral surface of the rod body portion. The rod body portion can be driven to move up and down by the driving mechanism by means of the protruding column portion such that the battery pack can be unlocked. Through such a structure, the driving mechanism can be more flexibly arranged. Moreover, an extending length of the rod body portion can be flexibly designed and adjusted according to a connection position of the protruding column portion on the rod body portion, such that the unlocking device is more compact in structure.

In one embodiment, a cavity is provided in the unlocking guide block in an up-down penetrating manner. Unlocking guide slots in the same shape are provided on two side walls of the cavity. Two protruding column portion portions are arranged on two sides of the rod body portion correspondingly. The protruding column portions on the two sides are arranged in the unlocking guide slots.

In the above embodiment, by using the above structural form, the unlocking guide slot in the cavity is symmetrically designed such that when the unlocking guide slot acts on the unlocking member, stress is more balanced and a movement is more stable.

In one embodiment, the unlocking rod includes the protruding column portion. A through hole is provided on the rod body portion. The protruding column portion passes through the through hole, such that the protruding column portions are formed on the two sides of the rod body portion respectively.

In the above embodiment, by using the above structural form, the rod body portion and the protruding column are of detachable structures such that the unlocking member can be conveniently detached and mounted, and parts can be conveniently replaced.

In one embodiment, the rod body portion includes a first rod body and a second rod body. The second rod body is connected to the protruding column portion. The first rod body is arranged at one end of the second rod body close to the battery pack. One end of the first rod body away from the second rod body is a cambered surface.

In the above embodiment, by using the above structural form, one end of the unlocking member extending into the battery pack is cambered such that when the unlocking member is inserted into the battery pack to trigger an unlocking connection rod, damage to the battery pack can be prevented, and an internal structure of the battery pack can be protected.

In one embodiment, the first rod body is of a conical structure.

In the above embodiment, by using the above structural form, through the design of the conical structure of the end of the first rod body, a certain deviation error is allowed when the unlocking member is inserted into the battery pack, such that precision of inserting the unlocking member into the battery pack is improved.

In one embodiment, an anti-rotating surface is arranged on an outer surface of the rod body portion and configured to prevent the rod body portion from rotating in the unlocking guide block.

In the above embodiment, by using the above structural form, the anti-rotating surface is arranged on an outer side of the rod body portion such that the rod body portion can be prevented from rotating when the driving mechanism drives the unlocking member to move up and down.

In one embodiment, the unlocking device further includes a detecting member. The detecting member is arranged on the unlocking guide block and configured to detect lifting of the unlocking rod; and/or the detecting member is configured to detect a horizontal movement of the unlocking guide block.

In the above embodiment, by using the above structural form, the driving mechanism is detected by the first detecting member such that the driving mechanism can be ensured to perform driving in place. The second detecting member is configured to detect the unlocking rod such that the unlocking rod can be ensured to normally move and perform unlocking after the driving mechanism moves. The battery pack can be unlocked only when the unlocking rod moves to the second set position. Whether the unlocking rod moves to a set position is detected by the second detecting member such that normal unlocking can be ensured.

In one embodiment, the detecting member includes: a first detecting member for detecting whether the unlocking guide block moves to a first set position; and a second detecting member for detecting whether the unlocking rod moves upwards to a second set position.

In the above embodiment, by using the above structural form, the unlocking rod is driven to move by the driving mechanism so as to unlock the battery pack. The driving mechanism is detected by the first detecting member such that the driving mechanism can be ensured to perform driving in place. The second detecting member is configured to detect the unlocking rod such that the unlocking rod can be ensured to normally move and perform unlocking after the driving mechanism moves. The battery pack can be unlocked only when the unlocking rod moves to the second set position. Whether the unlocking rod moves to a set position is detected by the second detecting member such that normal unlocking can be ensured.

In one embodiment, the detecting member further includes a third detecting member for detecting that the unlocking guide block moves to a third set position in a direction close to the driving mechanism and controlling the driving mechanism to be closed.

In the above embodiment, by using the above structural form, a stroke of a backward movement of the unlocking guide block can be ensured to be not excessive by the third detecting member such that the structure of an unlocking rod lifting detecting device can be protected, and service life of the unlocking rod lifting detecting device can be prolonged.

In one embodiment, the unlocking device includes a fixing portion member. The first detecting member and the second detecting member are fixedly mounted on the fixing portion member.

In the above embodiment, by using the above structural form, the detecting member can be fixedly mounted by the fixing portion member. Mounting stability of the detecting member can be ensured by the fixing portion member such that detecting precision of the detecting member can be ensured.

In one embodiment, the fixing portion member includes a mounting body and at least one adjusting body. The first detecting member and/or the second detecting member are connected to the adjusting body. The adjusting body is movably connected to the mounting body.

In the above embodiment, by using the above structural form, a split design is used for the fixing portion member. The fixing portion member includes a plate-shaped mounting body vertically fixed parallel to the unlocking guide block. The first detecting member, the second detecting member and the third detecting member are movably mounted on the mounting body by means of the adjusting body. By using the adjusting body, a mounting position of the detecting member can be conveniently adjusted, and the detecting member can be conveniently detached and mounted.

In one embodiment, an adjusting groove is provided on the adjusting body. A mounting position of the first detecting member is adjusted in a driving direction of the driving mechanism through the adjusting groove. A mounting position of the second detecting member is adjusted in an unlocking direction of the unlocking rod through the adjusting groove.

In the above embodiment, by using the above structural form, the mounting position of the detecting member is adjusted by the adjusting body through the adjusting groove such that detecting precision of each detecting member can be ensured. Moreover, adjusting directions of the first detecting member and the second detecting member relative to the adjusting groove are related to moving directions of the first detecting member and the second detecting member relative to a moving component such that the detecting member can be finely adjusted.

In one embodiment, a detecting port is provided on the fixing portion member. A detecting position on the unlocking rod is exposed through the detecting port.

In the above embodiment, by using the above structural form, the detecting port is provided on the fixing portion member. The detecting position of the unlocking rod corresponds to the detecting port. An up-down movement condition of the unlocking rod can be detected by the detecting member through the detecting port.

In one embodiment, the second detecting member is mounted on the detecting port. A detecting surface is arranged at one end of the unlocking rod facing the second detecting member.

In the above embodiment, by using the above structural form, through the design of the detecting surface, a position of the protruding column can be favorably detected such that a movement position of the rod body portion can be determined.

In one embodiment, the detecting member is a proximity switch.

In the above embodiment, by using the above structural form, the first detecting member and the third detecting member play a role of limiting a limit stroke of a left-right movement of the unlocking guide block such that precise unlocking can be ensured, and the unlocking device can be protected.

In one embodiment, the unlocking device further includes a horizontal guide mechanism, and the unlocking guide block is driven, by the driving mechanism, to horizontally move in the horizontal guide mechanism, such that the unlocking rod moves up and down along the unlocking guide slot.

In the above embodiment, by using the above structural form, a horizontal movement of the unlocking guide block is guided and restrained by means of the horizontal guide mechanism such that the unlocking rod can be ensured to stably move up and down along the unlocking guide slot to implement unlocking, and a space can be saved in a vertical direction.

In one embodiment, the horizontal guide mechanism includes a horizontal guide frame. A horizontal guide slot is provided in the horizontal guide frame. The horizontal guide slot is configured to guide the unlocking guide block to horizontally move.

In the above embodiment, by using the above structural form, a horizontal movement of the unlocking guide block is guided and restrained by means of the horizontal guide mechanism such that the unlocking rod can be ensured to stably move up and down along the unlocking guide slot to implement unlocking, and a space can be saved in a vertical direction.

In one embodiment, the unlocking device further includes a vertical guide mechanism fixedly arranged on the horizontal guide mechanism. The unlocking rod can penetrate the vertical guide mechanism to move up and down.

In the above embodiment, by using the above structural form, the vertical guide mechanism for guiding the unlocking rod is arranged such that the unlocking rod can be ensured to move up and down in a predetermined direction and prevented from tilting left and right. Further, the unlocking rod can be aligned with an unlocking position and implements unlocking rapidly.

In one embodiment, a snap-fitting groove is provided at one end of the unlocking guide block close to the driving mechanism. The driving mechanism includes a thrust output end and a connection block fixed to the thrust output end. The connection block is embedded in the snap-fitting groove.

In the above embodiment, by using the above structural form, through the design of the snap-fitting groove, the driving mechanism can be conveniently connected to the unlocking guide block.

In one embodiment, the unlocking rod is a torque unlocking rod. The torque unlocking rod applies torque to match a locking and unlocking mechanism to implement unlocking.

In the above embodiment, through such a structure and unlocking form, the unlocking rod can be suitable for various unlocking environments.

A battery swapping apparatus is configured to replace a battery pack in an electric vehicle. The battery swapping apparatus includes the above unlocking device.

In one embodiment, the battery swapping apparatus further includes a battery tray. A kidney-shaped hole is provided on the battery tray. The battery tray is configured to carry the battery pack. The unlocking device is arranged below the battery tray and configured to pass through the kidney-shaped hole to unlock the battery pack.

In the above embodiment, by using the above structural form, the avoidance groove is provided such that an upper battery pack fixing plate can be prevented from shielding the unlocking member, and interference with work of the unlocking member can be avoided. The kidney-shaped hole is provided for the rod body portion to favorably pass through.

In one embodiment, the battery swapping apparatus further includes a mounting component. The mounting component is arranged below the battery tray. The unlocking device is arranged on the mounting component.

In the above embodiment, by using the above structural form, the mounting component is arranged below the battery tray. The unlocking device is arranged on the mounting component. The unlocking rod of the unlocking device moves upwards and can pass through the kidney-shaped hole on the battery tray.

In one embodiment, the mounting component includes: a vehicle body fixing plate for being connected and fixed to a vehicle body of the electric vehicle; and a battery pack fixing plate for being connected and fixed to the battery pack. The unlocking device is mounted on the vehicle body fixing plate or the battery pack fixing plate.

In the above embodiment, by using the above structural form, relative movements of the vehicle body and a battery swapping shuttle vehicle can be prevented by the vehicle body fixing plate such that the battery swapping shuttle vehicle can smoothly lock and unlock the battery pack. Relative movements of the battery swapping shuttle vehicle and the battery pack can be prevented by the battery pack fixing plate such that the battery pack can be favorably locked and unlocked.

In one embodiment, the battery pack fixing plate is arranged above the vehicle body fixing plate. The unlocking device is mounted on the vehicle body fixing plate. An avoidance groove is provided at one end of the battery pack fixing plate close to the unlocking device. The unlocking device passes through the avoidance groove to be fixed to the vehicle body fixing plate.

In the above embodiment, by using the above structural form, the avoidance groove is provided such that the upper battery pack fixing plate can be prevented from shielding the unlocking rod, and interference with work of the unlocking member can be avoided.

In one embodiment, guide surfaces are arranged on two sides of the unlocking rod close to parallel surfaces of the kidney-shaped hole, or the guide surfaces are parallel to the parallel surfaces of the kidney-shaped hole.

In the above embodiment, by using the above structural form, the unlocking rod keeps moving in the same plane when moving up and down such that operation stability of the unlocking rod can be improved.

A battery pack includes the above unlocking device.

On the basis of conforming to common general knowledge in the art, the above preferred conditions can be arbitrarily combined such that preferred embodiments of the present disclosure can be obtained.

Positive progressive effects of the present disclosure lie in that:
the unlocking device in the present disclosure can be widely applied to the field of battery swapping, especially application scenarios requiring efficient battery swapping, such as a battery swapping apparatus, a battery swapping shuttle vehicle, and an electric vehicle. When the unlocking device performs unlocking, the unlocking guide block in a plane is driven by the driving mechanism to drive the unlocking rod to move up and down such that the battery pack can be unlocked. Through such a structural form, a height of the unlocking device can be effectively reduced such that the unlocking device can play a better role in a narrow environment. The unlocking rod, the unlocking guide block, etc. in the unlocking device in the present disclosure are simple in structure and convenient to manufacture. Moreover, the detecting member is arranged in the unlocking device. The detecting member can detect the driving mechanism during unlocking such that the driving structure can be ensured to perform driving in place. Moreover, the detecting member can detect the unlocking rod such that the unlocking rod can be ensured to normally move and perform unlocking after the driving mechanism moves. Therefore, the unlocking device can be ensured to efficiently and accurately operate, and the unlocking device can be protected.

### BRIEF DESCRIPTION OF THE DRAWINGS

FIG. 1 is a schematic structural diagram of a battery swapping shuttle vehicle according to an embodiment of the present disclosure.

FIG. 2 is a schematic structural diagram of a battery swapping apparatus according to an embodiment of the present disclosure.

FIG. 3 is schematic structural diagram (I) of an unlocking rod lifting detecting device according to an embodiment of the present disclosure.

FIG. 4 is schematic structural diagram (II) of an unlocking rod lifting detecting device according to an embodiment of the present disclosure.

FIG. 5 is a schematic assembly diagram of an unlocking rod and an unlocking guide block according to an embodiment of the present disclosure.

FIG. 6 is a schematic mounting diagram of an unlocking rod according to an embodiment of the present disclosure.

FIG. 7 is a schematic structural diagram of an unlocking guide block according to an embodiment of the present disclosure.

FIG. 8 is a schematic structural diagram of an unlocking rod according to an embodiment of the present disclosure.

FIG. 9 is a schematic structural diagram of a vehicle body support according to an embodiment of the present disclosure.

FIG. 10 is a schematic structural diagram of an ejector pin in a battery pack according to an embodiment of the present disclosure.

FIG. 11 is a schematic structural diagram of a battery pack according to an embodiment of the present disclosure.

### DESCRIPTION OF REFERENCE NUMERALS

unlocking rod 1, rod body portion 11, first rod body 111, second rod body 112, anti-rotating surface 113, protruding column portion 12, through hole 121, detecting surface 13, unlocking guide block 2, unlocking guide slot 21, first guide portion 211, second guide portion 212, third guide portion 213, cavity 22, snap-fitting groove 23, driving mechanism 3, horizontal guide mechanism 4, horizontal guide slot 41, vertical guide mechanism 5, vertical guide slot 51, detecting member 6, first detecting member 61, second detecting member 62, third detecting member 63, fixing portion member 7, mounting body 71, adjusting body 72, adjusting groove 721, detecting port 73, battery tray 8, kidney-shaped hole 81, mounting component 9, vehicle body fixing plate 91, battery pack fixing plate 92, avoidance groove 93, ejector pin mechanism 400, locking mechanism 40, ejecting seat 41, and mounting support 5.

### DETAILED DESCRIPTION OF THE EMBODIMENTS

The present disclosure will be described more clearly and completely below by way of embodiment and in combination with accompanying drawings. However, the present disclosure cannot be limited to the scopes of embodiments.

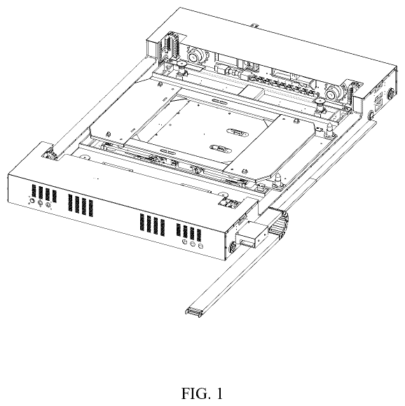

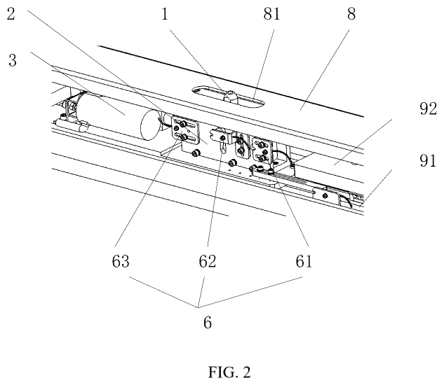

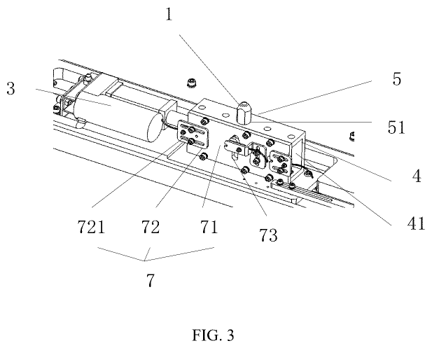

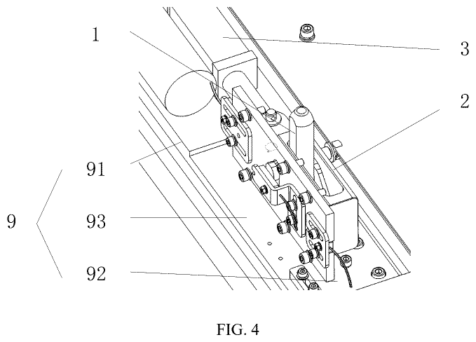

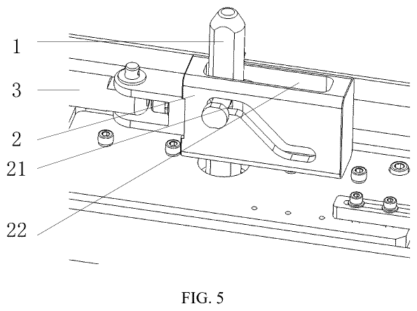

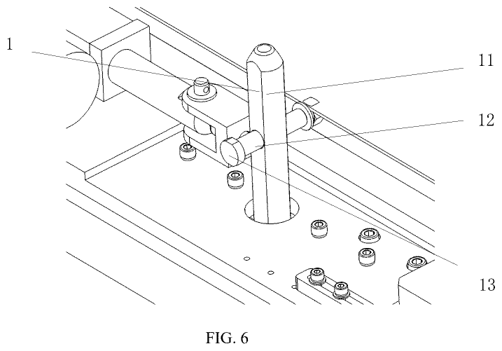

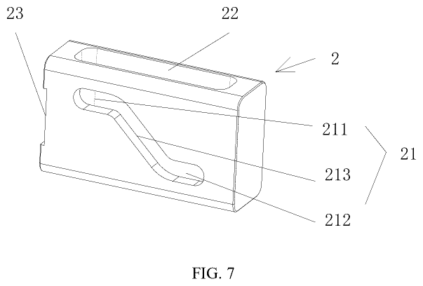

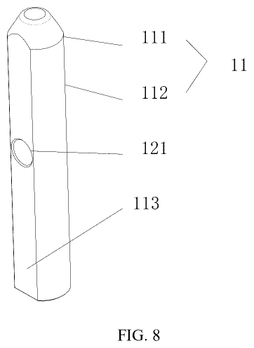

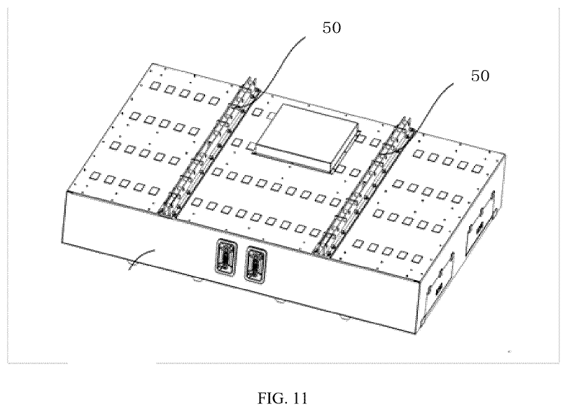

An embodiment of the present disclosure provides an unlocking device. As shown in FIGS. 1-11, the unlocking device includes: an unlocking rod 1, an unlocking guide block 2 and a driving mechanism 3. The driving mechanism 3 is connected to the unlocking guide block 2 and drives the unlocking guide block 2 to horizontally move. An unlocking guide slot 21 is provided on the unlocking guide block 2, and the unlocking rod 1 is driven to move up and down by the unlocking guide slot 21, such that a locking and unlocking structure for the electric vehicle and the battery pack is pushed by the unlocking rod 1 to carry out locking and unlocking.

In the embodiment, the unlocking device is arranged on the battery swapping apparatus and configured to be arranged on a battery swapping shuttle vehicle. The unlocking device can lock and unlock the battery pack in the electric vehicle, such that the battery pack in the electric vehicle is pushed by the unlocking rod 1 to be locked and unlocked, and the battery pack in the electric vehicle can be replaced. Certainly, the unlocking device may also be arranged on a battery pack of an electric vehicle, and a locking and unlocking structure for the electric vehicle and the battery pack is pushed by the unlocking rod 1 to carry out locking and unlocking such that the battery pack can be replaced.

In the embodiment, the unlocking rod 1 is vertically arranged. The unlocking rod 1 can be driven by the driving mechanism 3 to move up and down along an axis of the unlocking rod, and act on a locking mechanism 40 on the electric vehicle to unlock the locking mechanism 40 such that the battery pack can be separated from or combined with a vehicle body of the electric vehicle.

Moreover, in the embodiment, a horizontal movement of the driving mechanism 3 is concerted into an up-down movement of the unlocking rod 1 by the unlocking device by means of the unlocking guide block 2, such that a height of the unlocking device is reduced, and unlocking can be completed in a narrow space below a vehicle bottom. Further, the unlocking device is compact in a structural layout and beneficial to unlocking of various vehicle types.

As shown in FIGS. 1-11, a protruding column portion 12 extending to a side is arranged on the unlocking rod 1, and the protruding column portion 12 of the unlocking rod 1 is driven to move up and down by the unlocking guide slot 21 such that the battery pack in the electric vehicle can be unlocked by the unlocking rod 1.

In the embodiment, the unlocking guide block 2 and the driving mechanism 3 are horizontally arranged. The rod body portion 11 of the unlocking member is vertically mounted in the unlocking guide block 2. An unlocking guide slot 21 is provided on the unlocking guide block 2. The protruding column portion 12 of the unlocking member extends into the unlocking guide slot 21 to slidably match the unlocking guide slot 21. A split design is used for the driving mechanism 3. An unlocking member is driven to move by the driving mechanism 3 by means of the unlocking guide block 2. Through the split design, precision requirements of mounting positions of the driving mechanism 3 and the unlocking member can be reduced, and production cost can be reduced.

As shown in FIGS. 1-11, the unlocking device further includes a horizontal guide mechanism 4. The driving mechanism 3 is arranged at one end of the unlocking guide block 2, and the unlocking guide block 2 is driven by the driving mechanism 3 to horizontally move in the horizontal guide mechanism 4, such that the unlocking rod 1 moves up and down along the unlocking guide slot 21.

In the embodiment, the horizontal guide mechanism 4 includes a horizontal guide frame. A horizontal guide slot 41 is provided in the horizontal guide frame. The horizontal guide slot 41 is configured to guide the unlocking guide block 2 to horizontally move. A snap-fitting groove 23 is provided at one end of the unlocking guide block 2 close to the driving mechanism 3. The driving mechanism 3 includes a thrust output end and a connection block fixed to the thrust output end. The connection block is embedded in the snap-fitting groove 23.

In the present disclosure, a horizontal movement of the unlocking guide block 2 is guided and restrained by means of the horizontal guide mechanism 4 such that the unlocking rod 1 can be ensured to stably move up and down along the unlocking guide slot 21 to implement unlocking, and a space can be saved in a vertical direction.

As shown in FIGS. 1-11, the unlocking rod 1 is mounted in a left-right limiting manner relative to the horizontal moving direction.

In the embodiment, the unlocking guide slot 21 includes a first guide portion 211, a second guide portion 212 and a third guide portion 213. In other embodiments, the unlocking guide slot 21 may be an inclined guide slot for guiding the unlocking rod 1 to extend from a lowest position to a highest position. The inclined guide slot is provided on a side wall, in a direction parallel to a moving direction of the unlocking guide block, of the unlocking guide block 2.

In the embodiment, an extending direction of the first guide portion 211 is the same as the moving direction of the unlocking guide block 2. The second guide portion 212 is parallel to the first guide portion 211 and located at a lower end of the first guide portion 211. One end of the third guide portion 213 is inclined downwards for communication from one end of the first guide slot close to the third guide portion 213, and the other end of the third guide portion 213 is in communication with one end of the second guide portion 212 close to the third guide portion 213. When the driving mechanism 3 drives the unlocking guide block 2 to move in a horizontal direction away from the driving mechanism 3. The unlocking guide block 2 drives the rod body portion 11 to move upwards such that the locking mechanism 40 on the electric vehicle can be unlocked by the unlocking member. The unlocking guide slot 21 includes the first guide portion 211 having the same moving direction as the unlocking guide block 2 and a second guide portion 212 parallel to the first guide portion 211 and located at the lower end of the first guide portion 211. By the first guide portion 211 and the second guide portion 212, a horizontal movement of the unlocking guide block 2 is ensured, and horizontal support for stay of a protruding portion of the unlocking member is provided. The unlocking guide slot further includes a third guide portion 213 inclined downwards from the first guide portion 211 to be in communication with the second guide portion 212. Therefore, the protruding portion of the locking rod can be ensured to move up and down.

As shown in FIGS. 1-11, the unlocking guide slot 21 includes: a first guide portion 211, where an extending direction of the first guide portion 211 is the same as the moving direction of the unlocking guide block 2; a second guide portion 212, where the second guide portion 212 is parallel to the first guide portion 211 and located at a lower end of the first guide portion 211; and a third guide portion 213, where one end of the third guide portion 213 is inclined downwards for communication from one end of the first guide slot close to the third guide portion 213, and the other end of the third guide portion 213 is in communication with one end of the second guide portion 212 close to the third guide portion 213.

In the embodiment, the unlocking guide slot 21 includes the first guide portion 211, the second guide portion 212 and the third guide portion 213. The extending direction of the first guide portion 211 is the same as the moving direction of the unlocking guide block 2. The second guide portion 212 is parallel to the first guide portion 211 and located at a lower end of the first guide portion 211. One end of the third guide portion 213 is inclined downwards for communication from one end of the first guide slot close to the third guide portion 213, and the other end of the third guide portion 213 is in communication with one end of the second guide portion 212 close to the third guide portion 213.

In the embodiment, the unlocking guide slot 21 includes the first guide portion 211 having the same moving direction as the unlocking guide block 2 and a second guide portion 212 parallel to the first guide portion 211 and located at the lower end of the first guide portion 211. By the first guide portion 211 and the second guide portion 212, a horizontal movement of the unlocking guide block 2 can be ensured, and horizontal support for stay of a protruding portion of the unlocking rod 1 can be provided. The unlocking guide slot further includes a third guide portion 213 inclined downwards from the first guide portion 211 to be in communication with the second guide portion 212. Therefore, the protruding portion of the locking rod can be ensured to move up and down. As shown in FIGS. 1-11, the unlocking device further includes a vertical guide slot 51. A highest point of the vertical guide slot 51 is higher than or as high as a top end of the first guide portion 211. A lowest point of the vertical guide slot 51 is lower than or as low as a bottom end of the second guide portion 212. When the unlocking rod 1 is located at the highest position, one end of the first guide portion 211 away from the third guide portion 213 corresponds to a left-side position of the vertical guide slot 51, or one end of the first guide portion 211 away from the third guide portion 213 is located on a left side of the vertical guide slot 51. When the unlocking rod 1 is located at the lowest position, one end of the second guide portion 212 away from the third guide portion 213 corresponds to a right-side position of the vertical guide slot 51, or one end of the second guide portion 212 away from the third guide portion 213 is located on a right side of the vertical guide slot 51.

In the embodiment, the vertical guide mechanism 5 for guiding the unlocking rod 1 is arranged such that the unlocking rod 1 can be ensured to move up and down in a predetermined direction and prevented from tilting left and right. Further, the unlocking rod can be aligned with an unlocking position and implements unlocking rapidly.

As shown in FIGS. 1-11, the unlocking guide slot 21 further includes: a first chamfer arranged at a joint between the first guide portion 211 and the third guide portion 213; and a second chamfer arranged at a joint between the second guide portion 212 and the third guide portion 213.

In the embodiment, a chamfer arranged at a corner of a Z-shaped unlocking guide slot 21 such that a friction force can be reduced when the protruding column portion 12 of the unlocking rod 1 moves in the horizontal guide slot 41. Further, a jam can be prevented and a smooth movement can be ensured.

As shown in FIGS. 1-11, the unlocking rod 1 includes the protruding column portion 12 and a rod body portion 11. The protruding column portion 12 extends from an outer peripheral surface of the rod body portion 11 into the unlocking guide slot 21 in a radial direction of the rod body portion 11. The unlocking guide slot 21 drives, by means of the protruding column portion 12, the rod body portion 11 to move up and down in the unlocking guide block 2.

In the embodiment, the rod body portion 11 is a columnar rod member. The protruding column portion 12 extends from the outer peripheral surface of the rod body portion 11 in the radial direction. The protruding column portion 12 is connected to the driving mechanism 3, and the rod body portion 11 can be driven to move up and down along an axis by driving the driving mechanism 3. When the rod body portion 11 moves upwards and acts on the locking mechanism 40 on the battery pack or the electric vehicle, the battery pack can be rapidly unlocked. The protruding column portion 12 is arranged on the outer peripheral surface of the rod body portion 11. The rod body portion 11 can be driven to move up and down by the driving mechanism 3 by means of the protruding column portion 12 such that the battery pack can be unlocked. Through such a structure, the driving mechanism 3 can be more flexibly arranged. Moreover, an extending length of the rod body portion 11 can be flexibly designed and adjusted according to a connection position of the protruding column portion 12 on the rod body portion 11, such that the unlocking device is more compact in structure.

As shown in FIGS. 1-11, a cavity 22 is provided in the unlocking guide block 2 in an up-down penetrating manner. Unlocking guide slots 21 in the same shape are provided on two side walls of the cavity 22. Two protruding column portions 12 are arranged on two sides of the rod body portion 11 correspondingly. The protruding column portions 12 on the two sides are arranged in the unlocking guide slots 21.

In the embodiment, the cavity 22 is provided in the unlocking guide block 2 in an up-down penetrating manner. The unlocking guide slots 21 in the same shape are provided on a side wall facing upwards and a side wall facing away from the battery pack of the cavity 22 correspondingly. The protruding column portions 12 on the unlocking member extend into the unlocking guide slots 21 along the rod body portion 11 respectively, and are slidably connected to the unlocking guide slots 21. When the driving mechanism 3 drives the unlocking guide block 2 to move, the protruding column portions 12 move in the unlocking guide slots 21 to drive the rod body portion 11 to move up and down. The unlocking guide slots 21 in the cavity 22 are symmetrically designed, such that when the unlocking guide slots 21 act on the unlocking member, stress is more balanced and a movement is more stable.

As shown in FIGS. 1-11, the unlocking rod 1 includes the protruding column portion 12. A through hole 121 is provided on the rod body portion 11. The protruding column portion 12 passes through the through hole 121, such that the protruding column portions 12 are formed on the two sides of the rod body portion 11 respectively.

In the embodiment, the protruding column portion 12 and the rod body portion 11 may also be of a split design. The through hole 121 is provided on the rod body portion 11 in a direction perpendicular to an axial direction of the rod body portion. The protruding column includes a bolt, a nut and a washer. The bolt is mounted in the through hole 121, such that two protruding column portions 12 are formed on the two sides of the rod body portion 11. The rod body portion 11 and the protruding column are of detachable structures such that the unlocking member can be conveniently detached and mounted, and parts can be conveniently replaced.

As shown in FIGS. 1-11, the rod body portion 11 includes a first rod body 111 and a second rod body 112. The second rod body 112 is connected to the protruding column portion 12. The first rod body 111 is arranged at one end of the second rod body 112 close to the battery pack. One end of the first rod body 111 away from the second rod body 112 is a cambered surface.

In the embodiment, an upper portion of the rod body portion 11 is the first rod body 111. The top of the first rod body 111 is designed as a cambered surface. A lower portion of the rod body portion 11 is the second rod body 112. The protruding column portions 12 extend from the outer surface of the second rod body 112 to two sides in the radial direction of the second rod body. One end of the unlocking member extending into the battery pack is cambered such that when the unlocking member is inserted into the battery pack to trigger an unlocking connection rod, damage to the battery pack can be prevented, and an internal structure of the battery pack can be protected.

As shown in FIGS. 1-11, In one embodiment, the first rod body 111 is of a conical structure.

In the embodiment, the upper end of the first rod body 111 is designed as a conical structure, and the top of the conical structure is a cambered surface. Through the design of the conical structure of the end of the first rod body 111, a certain deviation error is allowed when the unlocking member is inserted into the battery pack, such that precision of inserting the unlocking member into the battery pack is improved.

As shown in FIGS. 1-11, an anti-rotating surface 113 is arranged on an outer surface of the rod body portion 11 and configured to prevent the rod body portion 11 from rotating in the unlocking guide block 2.

In the embodiment, the rod body portion 11 is a cylindrical rod member. The anti-rotating surface 113 parallel to an axial section of the rod body portion is designed on the side surface of the rod body portion 11. When the driving mechanism 3 drives the rod body portion 11 to move up and down, the anti-rotating surface 113 is attached to an external structure such that the rod body portion 11 can only move in the plane. The anti-rotating surface 113 is arranged on an outer side of the rod body portion 11 such that the rod body portion 11 can be prevented from rotating when the driving mechanism 3 drives the unlocking member to move up and down.

As shown in FIGS. 1-11, the unlocking device further includes a detecting member 6. The detecting member 6 is arranged on the unlocking guide block 2 and configured to detect lifting of the unlocking rod 1; and/or the detecting member 6 is configured to detect a horizontal movement of the unlocking guide block 2.

In the embodiment, the driving mechanism 3 is detected by the first detecting member 61 such that the driving mechanism can be ensured to perform driving in place. The second detecting member 62 is configured to detect the unlocking rod 1 such that the unlocking rod 1 can be ensured to normally move and perform unlocking after the driving mechanism 3 moves. The battery pack can be unlocked only when the unlocking rod 1 moves to the second set position. Whether the unlocking rod 1 moves to a set position is detected by the second detecting member 62 such that normal unlocking can be ensured.

The detecting member 6 includes: a first detecting member 61, where the first detecting member 61 is configured to detect whether the unlocking guide block 2 moves to a first set position; and a second detecting member 62, where the second detecting member 62 is configured to detect whether the unlocking rod 1 moves upwards to a second set position.

In the embodiment, the first detecting member 61 is arranged at the first set position on one side of the driving mechanism 3. A first electrical signal can be generated by the first detecting member 61 when the first detecting member 61 detects that the driving mechanism 3 moves to the first set position. The second detecting member 62 is arranged at the second set position on one side of the unlocking rod 1. A second electrical signal can be generated by the second detecting member 62 when the second detecting member 62 detects that the unlocking rod 1 moves to the second set position. Whether the driving mechanism 3 and the unlocking rod 1 move in place can be determined by an unlocking rod lifting detecting device by receiving the first electrical signal and the second electrical signal.

In the present disclosure, the unlocking rod 1 is driven, by the driving mechanism 3, to move to unlock the battery pack. The driving mechanism 3 is detected by the first detecting member 61 such that the driving mechanism can be ensured to perform driving in place. The second detecting member 62 is configured to detect the unlocking rod 1 such that the unlocking rod 1 can be ensured to normally move and perform unlocking after the driving mechanism 3 moves. The battery pack can be unlocked only when the unlocking rod 1 moves to the second set position. Whether the unlocking rod 1 moves to a set position is detected by the second detecting member 62 such that normal unlocking can be ensured.

As shown in FIGS. 1-11, the detecting member 6 further includes a third detecting member 63. The third detecting member 63 is configured to detect that the unlocking guide block 2 moves to a third set position in a direction close to the driving mechanism 3 and control the driving mechanism 3 to be closed.

In the embodiment, the third set position is provided on one side of the unlocking guide block 2 close to a driver. The third detecting member 63 is mounted at the third set position. When the driver drives the unlocking guide block 2 to move backwards, the third detecting member 63 is arranged between the unlocking guide block 2 and the driver to determine a movement position of the unlocking guide block 2. By means of the third detecting member 63, a stroke of a backward movement of the unlocking guide block 2 can be ensured to be not excessive, the structure of the unlocking rod lifting detecting device can be protected, and service life of the unlocking rod lifting detecting device can be prolonged.

As shown in FIGS. 1-11, the unlocking device includes a fixing portion member 7. The first detecting member 61 and the second detecting member 62 are fixedly mounted on the fixing portion member 7.

In the embodiment, the first detecting member 61, the second detecting member 62 and the third detecting member 63 are fixedly mounted on one side of the fixing portion member 7 away from the unlocking guide block 2. The first detecting member 61 is mounted on one side of the fixing portion member 7 away from the driver. The second detecting member 62 is mounted at a position, corresponding to the unlocking rod 1, of the fixing portion member 7. The third detecting member 63 is mounted on one side of the fixing portion member 7 close to the driver. The detecting member 6 can be fixedly mounted by the fixing portion member 7. By the fixing portion member 7, mounting stability of the detecting member 6 can be ensured, and detecting precision of the detecting member 6 can be ensured.

As shown in FIGS. 1-11, the fixing portion member 7 includes a mounting body 71 and at least one adjusting body 72. The first detecting member 61 and/or the second detecting member 62 are connected to the adjusting body 72. The adjusting body 72 is movably connected to the mounting body 71.

In the embodiment, a split design is used for the fixing portion member 7. The fixing portion member 7 includes a plate-shaped mounting body 71 vertically fixed parallel to the unlocking guide block 2. The first detecting member 61, the second detecting member 62 and the third detecting member 63 are movably mounted on the mounting body 71 by means of the adjusting body 72. By using the adjusting body 72, a mounting position of the detecting member 6 can be conveniently adjusted, and the detecting member 6 can be conveniently detached or mounted.

As shown in FIGS. 1-11, an adjusting groove 721 is provided on the adjusting body 72. A mounting position of the first detecting member 61 can be adjusted in a driving direction of the driving mechanism 3 through the adjusting groove 721. A mounting position of the second detecting member 62 can be adjusted in an unlocking direction of the unlocking rod 1 through the adjusting groove 721.

In the embodiment, the adjusting groove 721 is provided on the adjusting body 72. The adjusting groove 721 is a kidney-shaped hole 81. A screw passes through the kidney-shaped hole 81 to connect the adjusting body 72 to the mounting body 71. Moreover, a length direction of the kidney-shaped hole 81 of the adjusting body 72 at the first detecting member 61 is horizontally set such that the position in the horizontal direction of the first detecting member 61 can be adjusted. The length direction of the kidney-shaped hole 81 of the adjusting body 72 at the second detecting member 62 is vertically set such that the position in the height direction of the second detecting member 62 can be adjusted. The mounting position of the detecting member 6 is detected by the adjusting body 72 through the adjusting groove 721 such that detecting precision of each detecting member 6 can be ensured. Moreover, adjusting directions of the first detecting member 61 and the second detecting member 62 relative to the adjusting groove 721 are related to moving directions of the first detecting member and the second detecting member relative to a moving component such that the detecting member 6 can be finely adjusted.

As shown in FIGS. 1-11, a detecting port 73 is provided on the fixing portion member 7. A detecting position on the unlocking rod 1 is exposed by the detecting port 73.

In the embodiment, the detecting port 73 is provided on the fixing portion member 7. The detecting position of the unlocking rod 1 corresponds to the detecting port 73. An up-down movement condition of the unlocking rod 1 can be detected by the detecting member 6 through the detecting port 73.

As shown in FIGS. 1-11, the second detecting member 62 is mounted on the detecting port 73. A detecting surface 13 is arranged at one end of the unlocking rod 1 facing the second detecting member 62.

In the embodiment, the protruding column portion 12 is rigidly connected to the rod body portion 11. An end surface on one side of the protruding column portion 12 away from the rod body portion 11 is the detecting surface 13. After the unlocking member moves, whether a movement height of the rod body portion 11 is in place is determined by a sensor by detecting the detecting surface 13. Through the design of the detecting surface 13, a position of the protruding column can be favorably detected such that a movement position of the rod body portion 11 can be determined.

The detecting member 6 is a proximity switch.

In the embodiment, when the first detecting member 61 detects that the unlocking guide block 2 moves to the first set position away from one end of the driver, a first electrical signal can be given out by the first detecting member 61 to be configured to determine that the unlocking guide block 2 is driven in place by a driver. When the second detecting member 62 detects that the unlocking rod 1 moves upwards to the second set position, a second electrical signal can be given out by the second detecting member 62 to be configured to determine that the unlocking rod 1 rises in place. When the third detecting member 63 detects that the unlocking guide block 2 moves to the third set position close to one end of the driver, a third electrical signal can be given out by the third detecting member 63 to be configured to determine that the unlocking guide block 2 retracts in place. The first detecting member 61 and the third detecting member 63 play a role of limiting a limit stroke of a left-right movement of the unlocking guide block 2 such that precise unlocking can be ensured and the unlocking device can be protected.

As shown in FIGS. 1-11, the unlocking device further includes a horizontal guide mechanism 4. The unlocking guide block 2 is driven, by the driving mechanism 3, to horizontally move in the horizontal guide mechanism 4, such that the unlocking rod 1 moves up and down along the unlocking guide slot 21.

In the embodiment, a horizontal movement of the unlocking guide block 2 is guided and restrained by means of the horizontal guide mechanism 4 such that the unlocking rod 1 can be ensured to stably move up and down along the unlocking guide slot 21 to implement unlocking, and a space can be saved in a vertical direction.

As shown in FIGS. 1-11, the horizontal guide mechanism 4 includes a horizontal guide frame. A horizontal guide slot 41 is provided in the horizontal guide frame. The horizontal guide slot 41 is configured to guide the unlocking guide block 2 to horizontally move.

In the embodiment, the horizontal guide slot 41 is configured to guide the unlocking guide block 2 to horizontally move. A snap-fitting groove 23 is provided at one end of the unlocking guide block 2 close to the driving mechanism 3. The driving mechanism 3 includes a thrust output end and a connection block fixed to the thrust output end. The connection block is embedded in the snap-fitting groove 23.

In the present disclosure, a horizontal movement of the unlocking guide block 2 is guided and restrained by means of the horizontal guide mechanism 4 such that the unlocking rod 1 can be ensured to stably move up and down along the unlocking guide slot 21 to implement unlocking, and a space can be saved in a vertical direction.

As shown in FIGS. 1-11, the unlocking device further includes a vertical guide mechanism 5 fixedly arranged on the horizontal guide mechanism 4. The unlocking rod 1 penetrates the vertical guide mechanism 5 to move up and down.

In the embodiment, the vertical guide mechanism 5 for guiding the unlocking rod 1 is arranged such that the unlocking rod 1 can be ensured to move up and down in a predetermined direction and prevented from tilting left and right. Further, the unlocking rod can be aligned with an unlocking position and implements unlocking rapidly.

As shown in FIGS. 1-11, a snap-fitting groove 23 is provided at one end of the unlocking guide block 2 close to the driving mechanism 3. The driving mechanism 3 includes a thrust output end and a connection block fixed to the thrust output end. The connection block is embedded in the snap-fitting groove 23.

In the embodiment, a snap-fitting groove 23 is provided at one end of the unlocking guide block 2 close to the driving mechanism 3. The driving mechanism 3 includes a thrust output end and a connection block fixed to the thrust output end. The connection block is embedded in the snap-fitting groove 23.

Through the design of the snap-fitting groove 23, the driving mechanism 3 can be conveniently connected to the unlocking guide block 2.

As shown in FIGS. 1-11, the battery swapping apparatus further includes a battery tray 8. A kidney-shaped hole 81 is provided on the battery tray 8. The battery tray 8 is configured to carry the battery pack. The unlocking device is arranged below the battery tray 8 and configured to pass through the kidney-shaped hole 81 to unlock the battery pack.

In the embodiment, an avoidance groove 93 is provided on a battery pack fixing plate 92. The unlocking member passes through the avoidance groove 93 to be fixed to a vehicle body fixing plate 91. Moreover, the battery tray 8 is mounted on the battery pack fixing plate 92. The kidney-shaped hole 81 is provided at a position, corresponding to the unlocking member, of the battery tray 8. When the unlocking guide block 2 drives the unlocking member to move up and down, the rod body portion 11 can pass through the kidney-shaped hole 81 to unlock the battery pack. The avoidance groove 93 is provided such that an upper battery pack fixing plate 92 can be prevented from shielding the unlocking member, and interference with work of the unlocking member can be avoided. The kidney-shaped hole 81 is provided for the rod body portion 11 to favorably pass through.

As shown in FIGS. 1-11, the battery swapping apparatus further includes a mounting component 9. The mounting component 9 is arranged below the battery tray 8. The unlocking device is arranged on the mounting component 9.

In the embodiment, the mounting component 9 is arranged below the battery tray 8. The unlocking device is arranged on the mounting component 9. The unlocking rod 1 of the unlocking device moves upwards and can pass through the kidney-shaped hole 81 on the battery tray 8.

As shown in FIGS. 1-11, the mounting component 9 includes: a vehicle body fixing plate 91, where the vehicle body fixing plate is configured to be connected and fixed to a vehicle body of the electric vehicle; and a battery pack fixing plate 92, where the battery pack fixing plate 92 is configured to be connected and fixed to the battery pack. The unlocking device is mounted on the vehicle body fixing plate 91 or the battery pack fixing plate 92.

In the embodiment, the mounting component 9 further includes a vehicle body fixing plate 91 and a battery pack fixing plate 92. The battery pack fixing plate 92 is configured to be connected to the battery pack for positioning. The battery pack fixing plate 92 is arranged above the vehicle body fixing plate 91. Relative movements of a vehicle body and a battery swapping shuttle vehicle can be prevented by the vehicle body fixing plate 91 such that the battery swapping shuttle vehicle can smoothly lock and unlock the battery pack. Relative movements of the battery swapping shuttle vehicle and the battery pack can be prevented by the battery pack fixing plate 92 such that the battery pack can be favorably locked and unlocked.

As shown in FIGS. 1-11, the battery pack fixing plate 92 is arranged above the vehicle body fixing plate 91. The unlocking device is mounted on the vehicle body fixing plate 91. An avoidance groove 93 is provided at one end of the battery pack fixing plate 92 close to the unlocking device. The unlocking device passes through the avoidance groove 93 to be fixed to the vehicle body fixing plate 91.

In the embodiment, the avoidance groove 93 is provided on the battery pack fixing plate 92. The unlocking rod 1 passes through the avoidance groove 93 to be fixed to the vehicle body fixing plate 91. The avoidance groove 93 is provided such that the upper battery pack fixing plate 92 can be prevented from shielding the unlocking rod 1, and interference with work of the unlocking member 1 can be avoided.

As shown in FIGS. 1-11, guide surfaces are arranged on two sides of the unlocking rod 1 close to parallel surfaces of the kidney-shaped hole 81, or the guide surfaces are parallel to the parallel surfaces of the kidney-shaped hole 81.

In the embodiment, the guide surfaces of the unlocking rod 1 are parallel to the parallel surfaces of the kidney-shaped hole 81. Thus, the unlocking rod 1 keeps moving in the same plane when moving up and down such that operation stability of the unlocking rod can be improved.

In the embodiment, the up-down movement of the unlocking rod 1 in the present disclosure can be completed through the horizontal movement of the driving mechanism 3 such that the height of the unlocking rod lifting detecting device can be reduced, and the unlocking rod lifting detecting device can more conveniently enter vehicle bottoms of electric vehicles having different chassis heights.

In another embodiment, the unlocking rod 1 is a torque unlocking rod. The torque unlocking rod applies torque to match a locking and unlocking mechanism to implement unlocking.

In this case, the unlocking rod 1 may be a torque gun. In a case that the locking and unlocking mechanism is a threaded lock, an external thread is arranged on an outer peripheral surface of the unlocking rod 1. When unlocking is required, the external thread is driven, by the unlocking rod 1, to move to perform unlocking with an internal thread on the locking and unlocking mechanism. In a case that the locking and unlocking mechanism is a T-shaped lock, a transverse rod is arranged at a top of the unlocking rod 1. The transverse rod is fixedly connected to the rod body portion 11 of the unlocking rod 1 such that the unlocking rod 1 is of a T-shaped structure. The unlocking rod 1 rotates to drive the transverse rod to change an angle. When the angle of the transverse rod is consistent with an opening angle of the T-shaped lock, the transverse rod is separated from an opening of the T-shaped lock to perform unlocking with the locking and unlocking mechanism. Through such a structure and unlocking form, the unlocking rod 1 can be suitable for various unlocking environments.

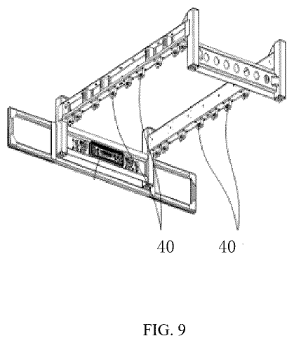

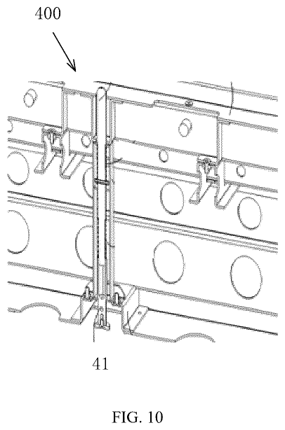

As shown in FIGS. 9-11, two vehicle body longitudinal beams of the electric vehicle are connected to a vehicle body support. The vehicle body support is of a frame-type structure welded by means of profiles. Each locking mechanism 40 is arranged at a lower surface position of the longitudinal beam of the vehicle body support and is configured to be in locking connection to a locking matching mechanism on the battery pack. Thus, the battery pack is connected to or separated from the vehicle body support such that a battery can be replaced. The locking mechanisms 40 are arranged in two rows at the lower surface of the vehicle body support so as to correspond to two vehicle body longitudinal beams respectively. As shown in FIG. 10, a hooking member at each mounting support 50 on the battery pack for an electric vehicle is configured to penetrate the locking mechanism 40 to implement locking.

During unlocking, the vehicle body fixing plate 91 and the battery pack fixing plate 92 move in a first direction such that a vehicle body positioning assembly and the battery pack fixing plate 92 can be adjusted to suitable positions according to a vehicle body positioning hole position of a vehicle type for replacement and a battery pack position. The vehicle body fixing plate 91 is lifted to be positioned with the vehicle body, and the battery pack fixing plate 92 is positioned by a positioning member and drives the battery pack to move. Since the battery pack fixing plate 92 can move, and the unlocking rod 1 is located on the battery pack fixing plate 92, a slide hole of the battery pack is configured as a kidney-shaped slide hole, or a slide hole having a diameter relatively larger than a moving stroke of the battery pack fixing plate 92 during unlocking.

During locking, the unlocking rod 1 rises to unlock the battery pack. The unlocking rod 1 rises into the slide hole of the battery pack and pushes an ejector pin in the battery pack, such that the ejector pin in the battery pack pushes the locking mechanism 40, and locking is released. The hooking member at the mounting support 50 on the battery pack is pushed into the L-shaped groove of the locking mechanism 40, such that locking is implemented.

During unlocking, the battery pack is driven, by the battery pack fixing plate 92, to move to the inner side of the L-shaped groove of the locking mechanism 40. The locking connection rod is pushed by the unlocking rod 1, such that the locking mechanism 40 is pushed by a locking connection rod, and the locking mechanism 40 is opened. The hooking member at the mounting support 50 of the battery pack is driven, by the battery pack fixing plate 92, to move to an unlocking port of the L-shaped groove, so as to exit the locking mechanism 40, and unlocking is implemented.

Specifically, as shown in FIGS. 9-11, an ejector pin mechanism 400 is pushed by the unlocking rod 1. The ejector pin is driven, by an ejecting seat 41 of the unlocking rod 1, to perform ejection upwards, so as to eject the locking connection rod of the locking mechanism 40, such that unlocking is implemented. Then, the hooking member at the mounting support 50 is pushed into the L-shaped groove, such that the locking connection rod of the locking mechanism 40 falls down to implement locking.

Although the particular embodiments of the present disclosure are described above, those skilled in the art should understand that these embodiments are merely illustrative, and the scope of protection of the present disclosure is defined by the appended claims. Those skilled in the art can make various alterations or modifications to the embodiments without departing from the principle and essence of the present disclosure. However, these alterations and modifications will fall within the scope of protection of the present disclosure.

What is claimed is:

1. An unlocking device configured to lock and unlock a battery pack in an electric vehicle, comprising:
an unlocking rod, an unlocking guide block and a driving mechanism, wherein the driving mechanism is connected to the unlocking guide block and drives the unlocking guide block to horizontally move; and
an unlocking guide slot is provided on the unlocking guide block, and the unlocking guide slot drives the unlocking rod to move up and down, such that the unlocking rod pushes a locking and unlocking structure for the electric vehicle and the battery pack to carry out locking and unlocking.

2. The unlocking device according to claim 1, wherein a protruding column portion extending to a side is arranged on the unlocking rod, and the unlocking guide slot drives the protruding column portion of the unlocking rod to move up and down, such that the unlocking rod unlocks the battery pack in the electric vehicle; and/or
the unlocking device further comprises a horizontal guide mechanism, the driving mechanism is arranged at one end of the unlocking guide block, and the driving mechanism drives the unlocking guide block to horizontally move in the horizontal guide mechanism, such that the unlocking rod moves up and down along the unlocking guide slot.

3. The unlocking device according to claim 1, wherein the unlocking rod is mounted in a left-right limiting manner relative to a horizontal moving direction, the unlocking guide slot is an inclined guide slot for guiding the unlocking rod to extend from a lowest position to a highest position, and the inclined guide slot is provided on a side wall, in a direction parallel to a moving direction of the unlocking guide block, of the unlocking guide block.

4. The unlocking device according to claim 3, wherein the unlocking guide slot comprises:
a first guide portion, wherein an extending direction of the first guide portion is the same as the moving direction of the unlocking guide block;
a second guide portion, wherein the second guide portion is parallel to the first guide portion and located at a lower end of the first guide portion; and
a third guide portion, wherein one end of the third guide portion is inclined downwards for communication from one end of the first guide slot close to the third guide portion, and the other end of the third guide portion is in communication with one end of the second guide portion close to the third guide portion.

5. The unlocking device according to claim 4, further comprising a vertical guide slot, a highest point of the vertical guide slot is higher than or as high as a top end of the first guide portion, and a lowest point of the vertical guide slot is lower than or as low as a bottom end of the second guide portion; when the unlocking rod is located at the highest position, one end of the first guide portion away from the third guide portion corresponds to a left-side position of the vertical guide slot, or one end of the first guide portion away from the third guide portion is located on a left side of the vertical guide slot; and when the unlocking rod is located at the lowest position, one end of the second guide portion away from the third guide portion corresponds to a right-side position of the vertical guide slot, or one end of the second guide portion away from the third guide portion is located on a right side of the vertical guide slot; and/or
the unlocking guide slot further comprises:
a first chamfer arranged at a joint between the first guide portion and the third guide portion; and
a second chamfer arranged at a joint between the second guide portion and the third guide portion.

6. The unlocking device according to claim 1, wherein the unlocking rod comprises the protruding column portion and a rod body portion, the protruding column portion extends from an outer peripheral surface of the rod body portion into the unlocking guide slot in a radial direction of the rod body portion, and the unlocking guide slot drives, by means of the protruding column portion, the rod body portion to move up and down in the unlocking guide block.

7. The unlocking device according to claim 6, wherein a cavity is provided in the unlocking guide block in an up-down penetrating manner, unlocking guide slots in the same shape are provided on two side walls of the cavity, two protruding column portions are arranged on two sides of the rod body portion correspondingly, and the protruding column portions on the two sides are arranged in the unlocking guide slots; and
preferably, the unlocking rod comprises the two protruding column portions, a through hole is provided on the rod body portion, and the protruding column portions pass through the through hole and are formed on the two sides of the rod body portion respectively.

8. The unlocking device according to claim 6, wherein the rod body portion comprises a first rod body and a second rod body, the second rod body is connected to the protruding column portion, the first rod body is arranged at one end of the second rod body close to the battery pack, and one end of the first rod body away from the second rod body is a cambered surface; and
preferably, the first rod body is of a conical structure.

9. The unlocking device according to claim 6, wherein an anti-rotating surface is arranged on an outer surface of the rod body portion and configured to prevent the rod body portion from rotating in the unlocking guide block.

10. The unlocking device according to claim 1, further comprising a detecting member, wherein the detecting member is arranged on the unlocking guide block and configured to detect ascent and descent of the unlocking rod; and/or
the detecting member is configured to detect a horizontal movement of the unlocking guide block; and
preferably, the detecting member is a proximity switch.

11. The unlocking device according to claim 10, wherein the detecting member comprises:
a first detecting member for detecting whether the unlocking guide block moves to a first set position; and
a second detecting member for detecting whether the unlocking rod moves upwards to a second set position; and
preferably, the detecting member further comprises a third detecting member for detecting that the unlocking guide block moves to a third set position in a direction close to the driving mechanism and controlling the driving mechanism to be closed.

12. The unlocking device according to claim 11, comprising a fixing portion member, wherein the first detecting member and the second detecting member are fixedly mounted on the fixing portion member.

13. The unlocking device according to claim 12, wherein the fixing portion member comprises a mounting body and at least one adjusting body, the first detecting member and/or the second detecting member are connected to the adjusting body, and the adjusting body is movably connected to the mounting body; and
preferably, an adjusting groove is provided on the adjusting body, a mounting position of the first detecting member is adjusted in a driving direction of the driving mechanism through the adjusting groove, and a mounting position of the second detecting member is adjusted in an unlocking direction of the unlocking rod through the adjusting groove.

14. The unlocking device according to claim 13, wherein a detecting port is provided on the fixing portion member, and the detecting port exposes a detecting position on the unlocking rod; and
preferably, the second detecting member is mounted on the detecting port, and a detecting surface is arranged at one end of the unlocking rod facing the second detecting member.

15. The unlocking device according to claim 1, wherein the unlocking device further comprises the horizontal guide mechanism, and the driving mechanism drives the unlocking guide block to horizontally move in the horizontal guide mechanism, such that the unlocking rod moves up and down along the unlocking guide slot;
preferably, the horizontal guide mechanism comprises a horizontal guide frame, a horizontal guide slot is provided in the horizontal guide frame, and the horizontal guide slot is configured to guide the unlocking guide block to horizontally move; and
preferably, the unlocking device further comprises a vertical guide mechanism fixedly arranged on the horizontal guide mechanism, and the unlocking rod penetrates the vertical guide mechanism to move up and down.

16. The unlocking device according to claim 1, wherein a snap-fitting groove is provided at one end of the unlocking guide block close to the driving mechanism, the driving mechanism comprises a thrust output end and a connection block fixed to the thrust output end, and the connection block is embedded in the snap-fitting groove; and/or
the unlocking rod is a torque unlocking rod, and the torque unlocking rod applies torque to match a locking and unlocking mechanism to implement unlocking.

17. A battery swapping apparatus configured to replace a battery pack in an electric vehicle, comprising the unlocking device according claim 1.

18. The battery swapping apparatus according to claim 17, further comprising a battery tray, wherein a kidney-shaped hole is provided on the battery tray, and the battery tray is configured to carry the battery pack;
the unlocking device is arranged below the battery tray and configured to pass through the kidney-shaped hole to unlock the battery pack; and
preferably, guide surfaces are arranged on two sides of the unlocking rod close to parallel surfaces of the kidney-shaped hole, or the guide surfaces are parallel to the parallel surfaces of the kidney-shaped hole.

19. The battery swapping apparatus according to claim 18, further comprising a mounting component, wherein the mounting component is arranged below the battery tray, and the unlocking device is arranged on the mounting component;
preferably, the mounting component comprises:
a vehicle body fixing plate for being connected and fixed to a vehicle body of the electric vehicle; and
a battery pack fixing plate for being connected and fixed to the battery pack; the unlocking device is mounted on the vehicle body fixing plate or the battery pack fixing plate; and
preferably, the battery pack fixing plate is arranged above the vehicle body fixing plate, the unlocking device is mounted on the vehicle body fixing plate, an avoidance groove is provided at one end of the battery pack fixing plate close to the unlocking device, and the unlocking device passes through the avoidance groove so as to be fixed to the vehicle body fixing plate.

20. A battery pack, comprising the unlocking device according to claim 1.
